(19) United States
(12) Patent Application Publication
(10) Pub. No.: US 2023/0164734 A1
(43) Pub. Date: May 25, 2023

(54) METHODS AND APPARATUSES FOR POSITIONING

(71) Applicant: Nokia Solutions and Networks Oy, Espoo (FI)

(72) Inventors: Fei GAO, Shanghai (CN); Gang SHEN, Shanghai (CN); Chaojun XU, Shanghai (CN)

(21) Appl. No.: 17/997,219

(22) PCT Filed: May 8, 2020
(86) PCT No.: PCT/CN2020/089137

§ 371 Date: Oct. 26, 2022

(51) Int. Cl. H04W 64/00; G01S 5/06

(52) U.S. Cl. CPC H04W 64/00; G01S 5/06

(57) ABSTRACT

Disclosed are methods for positioning. An example method may include sensing, at an apparatus in a space, at least one another apparatus in the space, determining first information including a position of the at least one another apparatus relative to the apparatus, transmitting the first information to the at least one another apparatus, and receiving from the at least one another apparatus second information including a position of the apparatus relative to the at least one another apparatus. Related apparatuses, system and computer readable media are also disclosed.

### TECHNICAL FIELD

Various example embodiments relate to methods and apparatuses for positioning.

### BACKGROUND

Various services, such as social networking, people finders, marketing campaigns, asset tracking, emergency aid, long-range medical treatment, remote assistance, and information supply, may be provided to a user or a user equipment (UE) of the user based on a location of the user or the UE.

### SUMMARY

In a first aspect, disclosed is a method including sensing, at an apparatus in a space, at least one another apparatus in the space, determining first information including a position of the at least one another apparatus relative to the apparatus, transmitting the first information to the at least one another apparatus, and receiving from the at least one another apparatus second information including a position of the apparatus relative to the at least one another apparatus. In some example embodiments, the apparatus and the at least one another apparatus may be wireless devices such as Wi-Fi devices of one or more access points and any other suitable wireless devices such as movable base stations.

In some example embodiments, the first information may be transmitted via at least one of broadcast, Transmission Control Protocol/Internet Protocol (TCP/IP), and User Datagram Protocol (UDP). In some example embodiments, the second information may be received via at least one of broadcast, TCP/IP, and UDP.

In some example embodiments, the first information may further include an identity of the apparatus. In some example embodiments, the second information may further include an identity of the at least one another apparatus.

In some example embodiments, the method in the first aspect may further include determining the position of the at least one another apparatus relative to the apparatus based on at least one of an angle of arrival and a time of arrival of the at least one another apparatus relative to the apparatus.

In some example embodiments, the method in the first aspect may further include sensing a UE in the space, determining at least one third information including one or more of an identity of the apparatus, an identity of the UE, at least one position of the UE relative to the apparatus, and at least one detection time of the position of the UE relative to the apparatus, and transmitting the at least one third information to the at least one second wireless device. In some example embodiments, the method in the first aspect may further include receiving from the at least one another apparatus at least one fourth information including one or more of an identity of the at least one another apparatus, the identity of the UE, at least one position of the UE relative to the at least one another apparatus, and at least one detection time of the position of the UE relative to the at least one another apparatus.

In some example embodiments, the at least one third information may be transmitted via broadcast, TCP/IP, and UDP. In some example embodiments, the at least one fourth information may be received via broadcast, TCP/IP, and UDP.

In some example embodiments, the method in the first aspect may further include determining the at least one position of the UE relative to the apparatus based on one or both of at least one angle of arrival and at least one time of arrival of the UE relative to the apparatus.

In some example embodiments, the method in the first aspect may further include determining at least one location of the UE in the space based on at least one of the first information, the second information, the at least one third information, and the at least one fourth information from the at least one another apparatus.

In some example embodiments, the method in the first aspect may further include determining a structure of the space based on the at least one location of the UE in the space.

In some example embodiments, the method in the first aspect may further include predicting an activity of the UE in the space based on the at least one location of the UE in the space.

In some example embodiments, the method in the first aspect may further include determining one or more of at least one outlier of the at least one location of the UE in the space, at least one cluster of the at least one location of the UE in the space, at least one trajectory of the at least one location of the UE in the space, and a relationship between the at least one location of the UE in the space and at least one detection time in the at least one of the at least one third information and the at least one fourth information.

In some example embodiments, the method in the first aspect may further include transmitting at least one of the first information, the second information, at least one location of a UE in the space, and information on a structure of the space to the UE.

In a second aspect, disclosed a method including receiving, at a UE, information from at least one apparatus in a space, the information including one or more of an identity of the at least one apparatus, a position relationship among the at least one apparatus, and at least one position of the UE in the space relative to the at least one apparatus.

In some example embodiments, the information may be received via at least one of broadcast, TCP/IP, and UDP.

In some example embodiments, the information may further include at least one of an identity of the UE and at least one detection time of the at least one position of the UE in the space relative to the at least one apparatus.

In some example embodiments, the method in the second aspect may further include determining the at least one location of the UE in the space based on the information.

In some example embodiments, the method in the second aspect may further include determining a structure of the space based on the at least one location of the UE in the space.

In some example embodiments, the method in the second aspect may further include predicting an activity of the UE in the space based on the at least one location of the UE in the space.

In some example embodiments, the method in the second aspect may further include determining one or more of at least one outlier of the at least one location of the UE in the space, at least one cluster of the at least one location of the UE in the space, at least one trajectory of the at least one location of the UE in the space, and a relationship between the at least one location of the UE in the space and at least one detection time in the information.

In a third aspect, an apparatus is disclosed. The apparatus may be configured to perform at least the method in the first aspect. For example, the apparatus in this aspect may include means for sensing at least one another apparatus in a space including the apparatus, means for determining first information including a position of the at least one another apparatus relative to the apparatus, means for transmitting the first information to the at least one another apparatus, and means for receiving from the at least one another apparatus second information including a position of the apparatus relative to the at least one another apparatus.

In some example embodiments, the first information may be transmitted via at least one of broadcast, TCP/IP, and UDP. In some example embodiments, the second information may be received via at least one of broadcast, TCP/IP, and UDP.

In some example embodiments, the first information may further include an identity of the apparatus. In some example embodiments, the second information may further include an identity of the at least one another apparatus.

In some example embodiments, the apparatus in the third aspect may further include means for determining the position of the at least one another apparatus relative to the apparatus based on at least one of an angle of arrival and a time of arrival of the at least one another apparatus relative to the apparatus.

In some example embodiments, the apparatus in the third aspect may further include means for sensing a UE in the space, means for determining at least one third information including one or more of an identity of the apparatus, an identity of the UE, at least one position of the UE relative to the apparatus, and at least one detection time of the position of the UE relative to the apparatus, and means for transmitting the at least one third information to the at least one second wireless device. In some example embodiments, the apparatus in the third aspect may further include means for receiving from the at least one another apparatus at least one fourth information including one or more of an identity of the at least one another apparatus, the identity of the UE, at least one position of the UE relative to the at least one another apparatus, and at least one detection time of the position of the UE relative to the at least one another apparatus.

In some example embodiments, the at least one third information may be transmitted via broadcast, TCP/IP, and UDP. In some example embodiments, the at least one fourth information may be received via broadcast, TCP/IP, and UDP.

In some example embodiments, the apparatus in the third aspect may further include means for determining the at least one position of the UE relative to the apparatus based on one or both of at least one angle of arrival and at least one time of arrival of the UE relative to the apparatus.

In some example embodiments, the apparatus in the third aspect may further include means for determining at least one location of the UE in the space based on at least one of the first information, the second information, the at least one third information, and the at least one fourth information from the at least one another apparatus.

In some example embodiments, the apparatus in the third aspect may further include means for determining a structure of the space based on the at least one location of the UE in the space.

In some example embodiments, the apparatus in the third aspect may further include means for predicting an activity of the UE in the space based on the at least one location of the UE in the space.

In some example embodiments, the apparatus in the third aspect may further include means for determining one or more of at least one outlier of the at least one location of the UE in the space, at least one cluster of the at least one location of the UE in the space, at least one trajectory of the at least one location of the UE in the space, and a relationship between the at least one location of the UE in the space and at least one detection time in the at least one of the at least one third information and the at least one fourth information.

In some example embodiments, the apparatus in the third aspect may further include means for transmitting at least one of the first information, the second information, at least one location of a UE in the space, and information on a structure of the space to the UE.

In a fourth aspect, disclosed is an apparatus including at least one processor and at least one memory. The at least one memory may include computer program code. The at least one memory and the computer program code may be configured to, with the at least one processor, cause the apparatus to perform at least the method in the first aspect. For example, the at least one memory and the computer program code may be configured to, with the at least one processor, cause the apparatus to perform at least sensing at least one another apparatus in a space including the apparatus, determining first information including a position of the at least one another apparatus relative to the apparatus, transmitting the first information to the at least one another apparatus, and receiving from the at least one another apparatus second information including a position of the apparatus relative to the at least one another apparatus.

In some example embodiments, the first information may be transmitted via at least one of broadcast, TCP/IP, and UDP. In some example embodiments, the second information may be received via at least one of broadcast, TCP/IP, and UDP.

In some example embodiments, the first information may further include an identity of the apparatus. In some example embodiments, the second information may further include an identity of the at least one another apparatus.

In some example embodiments, in the apparatus in the fourth aspect, the at least one memory and the computer program code may be further configured to, with the at least one processor, cause the apparatus to perform determining the position of the at least one another apparatus relative to the apparatus based on at least one of an angle of arrival and a time of arrival of the at least one another apparatus relative to the apparatus.

In some example embodiments, in the apparatus in the fourth aspect, the at least one memory and the computer program code may be further configured to, with the at least one processor, cause the apparatus to perform sensing a UE in the space, determining at least one third information including one or more of an identity of the apparatus, an identity of the UE, at least one position of the UE relative to the apparatus, and at least one detection time of the position of the UE relative to the apparatus, and transmitting the at least one third information to the at least one another apparatus. In some example embodiments, in the apparatus in the fourth aspect, the at least one memory and the computer program code may be further configured to, with the at least one processor, cause the apparatus to perform receiving from the at least one another apparatus at least one fourth information including one or more of an identity of the at least one another apparatus, the identity of the UE, at least one position of the UE relative to the at least one another apparatus, and at least one detection time of the position of the UE relative to the at least one another apparatus.

In some example embodiments, the at least one third information may be transmitted via broadcast, TCP/IP, and UDP. In some example embodiments, the at least one fourth information may be received via broadcast, TCP/IP, and UDP.

In some example embodiments, in the apparatus in the fourth aspect, the at least one memory and the computer program code may be further configured to, with the at least one processor, cause the apparatus to perform determining the at least one position of the UE relative to the apparatus based on one or both of at least one angle of arrival and at least one time of arrival of the UE relative to the apparatus.

In some example embodiments, in the apparatus in the fourth aspect, the at least one memory and the computer program code may be further configured to, with the at least one processor, cause the apparatus to perform determining at least one location of the UE in the space based on at least one of the first information, the second information, the at least one third information, and the at least one fourth information from the at least one another apparatus.

In some example embodiments, in the apparatus in the fourth aspect, the at least one memory and the computer program code may be further configured to, with the at least one processor, cause the apparatus to perform determining a structure of the space based on the at least one location of the UE in the space.

In some example embodiments, in the apparatus in the fourth aspect, the at least one memory and the computer program code may be further configured to, with the at least one processor, cause the apparatus to perform the at least one memory and the computer program code is further configured to, with the at least one processor, cause the apparatus to perform predicting an activity of the UE in the space based on the at least one location of the UE in the space.

In some example embodiments, in the apparatus in the fourth aspect, the at least one memory and the computer program code may be further configured to, with the at least one processor, cause the apparatus to perform determining one or more of at least one outlier of the at least one location of the UE in the space, at least one cluster of the at least one location of the UE in the space, at least one trajectory of the at least one location of the UE in the space, and a relationship between the at least one location of the UE in the space and at least one detection time in the at least one information in the at least one third information and/or the at least one fourth information.

In some example embodiments, in the apparatus in the fourth aspect, the at least one memory and the computer program code may be further configured to, with the at least one processor, cause the apparatus to perform transmitting at least one of the first information, the second information, at least one location of a UE in the space, and information on a structure of the space to the UE.

In a fifth aspect, disclosed is a system including at least one first apparatus and at least one second apparatus. For example, one or more of the at least one first apparatus and the at least one second apparatus may be configured to perform at least the method in the first aspect. For example, the at least one first apparatus may be configured to sense the at least one second apparatus, to determine first information including a position of the at least one second apparatus relative to the at least one first apparatus, to transmit the first information, and to receive second information including a position of the at least one first apparatus relative to the at least one second apparatus. The at least one second apparatus may be configured to sense the at least one first apparatus, to determine the second information, to transmit the second information, and to receive the first information.

In some example embodiments, at least one of the first information and the second information is transmitted via at least one of broadcast, TCP, and UDP.

In some example embodiments, the first information may further include an identity of the at least one first apparatus, and/or the second information further includes an identity of the at least one second apparatus.

In some example embodiments, the at least one first apparatus may be further configured to sense a UE in a space including the system, to determine at least one third information including one or more of an identity of the at least one first apparatus, an identity of the UE, at least one position of the UE relative to the at least one first apparatus, and at least one detection time of the position of the UE relative to the at least one first apparatus, and to transmit the at least one third information to the at least one second apparatus.

In some example embodiments, the at least one second apparatus may be further configured to sense the UE in the space, to determine at least one fourth information including one or more of an identity of the at least one second apparatus, an identity of the UE, at least one position of the UE relative to the at least one second apparatus, and at least one detection time of the position of the UE relative to the at least one second apparatus, and to transmit the at least one fourth information to the at least one first apparatus.

In some example embodiments, one or more of the at least one first apparatus and the at least one second apparatus may be further configured to determine at least one location of the UE in the space based on at least one of the first information, the second information, the at least one third information, and the at least one fourth information.

In some example embodiments, one or more of the at least one first apparatus and the at least one second apparatus may be further configured to determine a structure of the space based on the at least one location of the UE in the space.

In some example embodiments, one or more of the at least one first apparatus and the at least one second apparatus may be further configured to predict an activity of the UE in the space based on the at least one location of the UE in the space.

In some example embodiments, one or more of the at least one first apparatus and the at least one second apparatus may be further configured to determine one or more of at least one outlier of the at least one location of the UE in the space, at least one cluster of the at least one location of the UE in the space, at least one trajectory of the at least one location of the UE in the space, and a relationship between the at least one location of the UE in the space and at least one detection time in the at least one of the at least one third information and the at least one fourth information.

In a sixth aspect, an apparatus is disclosed. The apparatus may be configured to perform at least the method in the second aspect. For example, the apparatus in this aspect may include means for receiving information from at least one another apparatus in a space, the information including one or more of an identity of the at least one another apparatus, a position relationship among the at least one another apparatus, and at least one position of the apparatus in the space relative to the at least one another apparatus. For example, the apparatus in this aspect may be at least a part of a UE.

In some example embodiments, the information may be received via at least one of broadcast, TCP/IP, and UDP.

In some example embodiments, the information may further include at least one of an identity of the apparatus and at least one detection time of the at least one position of the apparatus in the space relative to the at least one another apparatus.

In some example embodiments, the apparatus in the sixth aspect may further include means for determining the at least one location of the apparatus in the space based on the information.

In some example embodiments, the apparatus in the sixth aspect may further include means for determining a structure of the space based on the at least one location of the apparatus in the space.

In some example embodiments, the apparatus in the sixth aspect may further include means for predicting an activity of the apparatus in the space based on the at least one location of the apparatus in the space.

In some example embodiments, the apparatus in the sixth aspect may further include means for determining one or more of at least one outlier of the at least one location of the apparatus in the space, at least one cluster of the at least one location of the apparatus in the space, at least one trajectory of the at least one location of the apparatus in the space, and a relationship between the at least one location of the apparatus in the space and at least one detection time in the information.

In a seventh aspect, disclosed is an apparatus including at least one processor and at least one memory. The at least one memory may include computer program code. The at least one memory and the computer program code may be configured to, with the at least one processor, cause the apparatus to perform at least the method in the second aspect. For example, the at least one memory and the computer program code may be configured to, with the at least one processor, cause the apparatus to perform at least receiving information from at least one another apparatus in a space, the information including one or more of an identity of the at least one another apparatus, a position relationship among the at least one another apparatus, and at least one position of the apparatus in the space relative to the at least one another apparatus. For example, the apparatus in this aspect may be at least a part of a UE.

In some example embodiments, the information may be received via at least one of broadcast, TCP/IP, and UDP.

In some example embodiments, the information may further include at least one of an identity of the apparatus and at least one detection time of the at least one position of the apparatus in the space relative to the at least one another apparatus.

In some example embodiments, in the apparatus in the seventh aspect, the at least one memory and the computer program code may be further configured to, with the at least one processor, cause the apparatus to perform determining the at least one location of the apparatus in the space based on the information.

In some example embodiments, in the apparatus in the seventh aspect, the at least one memory and the computer program code may be further configured to, with the at least one processor, cause the apparatus to perform determining a structure of the space based on the at least one location of the apparatus in the space.

In some example embodiments, in the apparatus in the seventh aspect, the at least one memory and the computer program code may be further configured to, with the at least one processor, cause the apparatus to perform predicting an activity of the apparatus in the space based on the at least one location of the apparatus in the space.

In some example embodiments, in the apparatus in the seventh aspect, the at least one memory and the computer program code may be further configured to, with the at least one processor, cause the apparatus to perform determining one or more of at least one outlier of the at least one location of the apparatus in the space, at least one cluster of the at least one location of the apparatus in the space, at least one trajectory of the at least one location of the apparatus in the space, and a relationship between the at least one location of the apparatus in the space and at least one detection time in the information.

In an eighth aspect, a computer readable medium is disclosed. The computer readable medium may include instructions stored thereon for causing an apparatus to perform the method in the first aspect. For example, the instructions may cause the apparatus to perform at least sensing at least one another apparatus in a space including the apparatus, determining first information including a position of the at least one another apparatus relative to the apparatus, transmitting the first information to the at least one another apparatus, and receiving from the at least one another apparatus second information including a position of the apparatus relative to the at least one another apparatus.

In some example embodiments, the instructions in the eighth aspect may further cause the apparatus to perform sensing a UE in the space, determining at least one third information including one or more of an identity of the apparatus, an identity of the UE, at least one position of the UE relative to the apparatus, and at least one detection time of the position of the UE relative to the apparatus, and transmitting the at least one third information to the at least one another apparatus.

In some example embodiments, the instructions in the eighth aspect may further cause the apparatus to perform determining at least one location of the UE in the space based on at least one of the first information, the second information, the at least one third information, and at least one fourth information from the at least one another apparatus, the at least one fourth information including one or more of an identity of the at least one another apparatus, the identity of the UE, at least one position of the UE relative to the at least one another apparatus, and at least one detection time of the position of the UE relative to the at least one another apparatus.

In some example embodiments, the instructions in the eighth aspect may further cause the apparatus to perform determining a structure of the space based on the at least one location of the UE in the space.

In some example embodiments, the instructions in the eighth aspect may further cause the apparatus to perform predicting an activity of the UE in the space based on the at least one location of the UE in the space.

In a ninth aspect, a computer readable medium is disclosed. The computer readable medium may include instructions stored thereon for causing an apparatus to perform the method in the second aspect. For example, the instructions may cause the apparatus to perform at least receiving information from at least one another apparatus in a space, the information including one or more of an identity of the at least one another apparatus, a position relationship among the at least one another apparatus, and at least one position of the apparatus in the space relative to the at least one another apparatus.

In some example embodiments, the instructions in the ninth aspect may further cause the apparatus to perform determining the at least one location of the apparatus in the space based on the information.

In some example embodiments, the instructions in the ninth aspect may further cause the apparatus to perform determining a structure of the space based on the at least one location of the apparatus in the space.

In some example embodiments, the instructions in the ninth aspect may further cause the apparatus to perform predicting an activity of the apparatus in the space based on the at least one location of the apparatus in the space.

### BRIEF DESCRIPTION OF THE DRAWINGS

Some example embodiments will now be described, by way of non-limiting examples, with reference to the accompanying drawings.

FIG. 1 illustrates an example method in an embodiment.

FIG. 2 illustrates an execution example the example method in an embodiment.

FIG. 3 illustrates an execution example the example method in an embodiment.

FIG. 4 illustrates an execution example the example method in an embodiment.

FIG. 5 illustrates an execution example the example method in an embodiment.

FIG. 6 illustrates an example method in an embodiment.

FIG. 7 illustrates an execution example the example method in an embodiment.

FIG. 8 illustrates an execution example the example method in an embodiment.

FIG. 9 illustrates an example method in an embodiment.

FIG. 10 illustrates an execution example the example method in an embodiment.

FIG. 11 illustrates an execution example the example method in an embodiment.

FIG. 12 illustrates an execution example the example method in an embodiment.

FIG. 13 illustrates an example apparatus in an embodiment.

FIG. 14 illustrates an example apparatus in an embodiment.

FIG. 15 illustrates an execution example the example method in an embodiment.

FIG. 16 illustrates an example method in an embodiment.

FIG. 17 illustrates an example apparatus in an embodiment.

FIG. 18 illustrates an example apparatus in an embodiment.

### DETAILED DESCRIPTION

In a positioning system, positions of one or more anchors may be configured in advance. For example, when utilizing Wi-Fi technologies for an indoor positioning, a private network may be designed, and the one or more Wi-Fi devices may be installed at predetermined locations in the designed private network so as to provide one or more access points. Then, for example, Global Positioning System (GPS) signals may be utilized for the positioning.

However, for example, in a case where the Wi-Fi devices are installed randomly without predetermined anchors or without considering predetermined anchors, or in a case where the Wi-Fi devices are moved occasionally so that the established network changes, or in a case where GPS signals are weak, the positioning system may suffer from accuracy degradation or failures of positioning.

Similar cases may be found in positioning based on other communication technologies such as Bluetooth® and radio frequency (RF), for example, in a case of positioning with movable base stations.

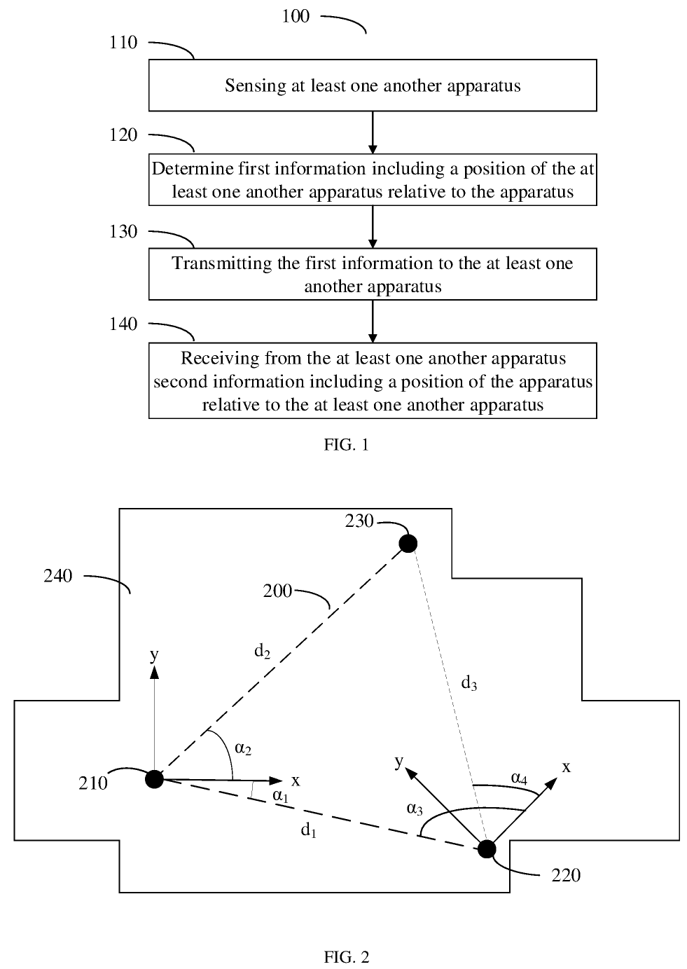

FIG. 1 illustrates an example method 100 for positioning in an example embodiment, which may be performed in an apparatus of a positioning network. For example, the apparatus may be, but is not limited to, a wireless apparatus which is installed randomly (for example, without predetermined anchors or not at predetermined installation positions) and/or movable, such as a Wi-Fi device installed randomly in a room, a movable base station (e.g. a movable base station vehicle), or the like.

As shown in FIG. 1, the example method 100 may include a step 110 of sensing at least one another apparatus in a space including the apparatus, a step 120 of determining first information including a position of the at least one another apparatus relative to the apparatus, a step 130 of transmitting the first information to the at least one another apparatus, and a step 140 of receiving from the at least one another apparatus second information including a position of the apparatus relative to the at least one another apparatus.

For example, the at least one another apparatus sensed by the apparatus in the example method 100 may be also included in the positioning network to be established, and may also perform the example method 100 so as to establish and scale a positioning network automatically through cooperation between the apparatus and the at least one another apparatus.

Through the example method 100, the apparatus may sense or detect an environment around it or a space where it locates currently. Then, for one or more another apparatuses in the environment or the space sensed by the apparatus (hereafter, also called as “one or more sensed apparatuses”), the apparatus may determine or measure positions of the one or more sensed apparatuses relative to the apparatus, for example by measuring or sensing distances and/or angles from the one or more sensed apparatuses to the apparatus, and may communicate with the one or more sensed apparatuses so as to interchange the information on position relationship between the apparatus and the one or more sensed apparatuses.

Thus, for example, the apparatus supporting the example method 100 may join automatically a positioning network previously including the one or more sensed apparatuses, or may enable one or more sensed apparatuses to be added automatically into a positioning network including the apparatus, for example even in a case where information on positions of anchors of the positioning network is not provided in advance to the apparatus, or in a case where the apparatus and/or one or more sensed apparatuses are installed randomly or somewhere rather than predetermined installation positions, or in a case where the positions of the apparatus and/or one or more sensed apparatuses may change, or the like. That is, through the example method 100, a self-organized and scalable positioning network may be established.

Further, for example, the installation and configuration of the apparatus supporting the example method 100 may be easier due to less or even no consideration on the anchors, and more types of apparatuses such as mobile base station and Mesh Wi-Fi devices may be utilized to establish a positioning network.

It is appreciated that the steps in the example method 100 are not limited to the order as shown in FIG. 1. For example, in various embodiments, the step 140 may be before or in parallel with the step 120 and/or the step 130. Moreover, the steps in the example method 100 may be implemented in one or more suitable manners.

In various embodiments, in the step 110, the apparatus may utilize any suitable manners to detect the space where the apparatus locates currently and to sense one or more another apparatuses in the space. For example, the apparatus may broadcast a signal and may detect or sense one or more another apparatuses based on one or more responses from the one or more another apparatuses. For example, the apparatus may listen to a specified frequency channel, and may detect or sense one or more another apparatuses based on information carried on the specified frequency channel. In another examples, the apparatus may capture audio, images, video, or the like, from or related to one or more another apparatuses in the space, and may detect or sense one or more another apparatuses based on analyses and/or recognitions for the captured audio, images, video, or the like.

In various embodiments, in the step 120, any suitable manners may be utilized to determine the positions of the one or more sensed apparatuses relative to the apparatus.

For example, in the step 120, an angle of arrival (AoA) and/or a time of arrival (ToA) of a sensed apparatus relative to the apparatus may be determined in any suitable manners, for example based on channel state information (CSI) shared between the apparatus and the sensed apparatus which may include information on fading factors on the transmission channel or path, such as signal scattering, multipath shading, power decay of distance, and the like, and then the position of the sensed apparatus relative to the apparatus may be determined based on the determined AoA and/or ToA.

In another example, in the step 120, the apparatus may measure the received signal strength (RSS) of a signal from the sensed apparatus to determine roughly a region of the sensed apparatus, and then may further determine an accurate position of the sensed apparatus relative to the apparatus based on CSI, for example by any suitable manners such as K-Means, machine learning, RF fingerprint matching, and the like.

In another example, in the step 120, the apparatus may also receive information from one or more of the sensed apparatuses to obtain a position of the apparatus relative to other apparatuses, and may determine the positions of the one or more sensed apparatuses relative to the apparatus based on the received information, rather than measuring the positions of the one or more sensed apparatuses relative to the apparatus by itself.

In various embodiments, in the step 130, the apparatus may transmit the first information including the positions of one or more sensed apparatuses relative to the apparatus determined in the step 120 to the one or more sensed apparatuses based on any suitable communication protocol such as Transmission Control Protocol/Internet Protocol (TCP/IP), User Datagram Protocol (UDP), and the like.

In an embodiment, in the step 130, the apparatus may broadcast the first information, through which, for example, the establishment and maintenance of multiple communication channels between the apparatus and the one or more sensed apparatuses may be avoided, and thus the scalability of the positioning network may be further improved.

In some embodiments, the first information may also include an identity of the apparatus.

Similarly, in various embodiments, in the step 140, the apparatus may receive the second information including the positions of the apparatus relative to the one or more sensed apparatuses based on any suitable communication protocols such as TCP/IP, UDP, and the like. In an embodiment, the apparatus may listen to the broadcast channel for the second information. In some embodiments, the second information may also include identities of the one or more sensed apparatus.

Then, based on the information communicated with the apparatus and the one or more sensed apparatuses, a positioning network or system may be established.

FIG. 2 illustrate an example system 200 in an example embodiment, which may be a self-organized and scalable positioning network established by one or more apparatuses supporting the example method 100, wherein an apparatus 210 supporting the example method 100 is configured or installed in the space 240 and detects another apparatus 220 and 230 in the space 240 in the step 110 of the example method 100. In various embodiments, examples of the apparatuses 210, 220, and 230 may include, but are not limited to, wireless apparatuses which may be installed randomly (for example, without predetermined anchors or not at predetermined installation positions) and/or movable, such as Wi-Fi devices installed randomly in a room, movable base stations (e.g. movable base station vehicles), or the like.

Then, in the step 120, for example, the apparatus 210 may determine a distance d₁ between the apparatuses 210 and 220, and a distance d₂ between the apparatuses 210 and 230, so as to determine at least a part of the information on the position of the apparatus 220 relative to the apparatus 210 and at least a part of the information on the position of the apparatus 230 relative to the apparatus 210. For example, time may be synchronized among the apparatuses 210, 220, and 230, and then the apparatus 210 may send testing signals to the apparatus 220 and the apparatus 230, and may obtain a signal transmission time to the apparatus 220 based on a measured ToA at the apparatus 220, and a signal transmission time to the apparatus 230 based on a measured ToA at the apparatus 230. Then, the distance d₁ between the apparatuses 210 and 220, and the distance d₂ between the apparatuses 210 and 230 may be calculated based on the obtained signal transmission time and speed of light. Then, the apparatus 210 may transmit the determined information to the apparatuses 220 and 230 in the step 130.

Similarly, the apparatus 220 may also determine a distance between the apparatuses 220 and 210, and a distance d₃ between the apparatuses 220 and 230, so as to determine at least a part of the information on the position of the apparatus 210 relative to the apparatus 220 and at least a part of the information on the position of the apparatus 230 relative to the apparatus 220, and then may transmit the determined information to at least one of the apparatuses 210 and 230 in the step 130.

The apparatus 210 may receive the information from the apparatus 220 in the step 140, and may obtain information on the distance between the apparatuses 210 and 220 measured by the apparatus 220 and the distance between the apparatuses 220 and 230 measured by the apparatus 220. In a case where the distance between the apparatuses 210 and 220 measured by the apparatus 220 is different from d₁ measured by the apparatuses 210, any suitable manners may be adopted to solve the conflict. For example, one of the two measured distance values may be selected, or a new distance value may be determined as the distance between the apparatuses 210 and 220 based on the two measured distance values, or the like.

Then, the apparatus 210 may determine the coordinates of the apparatus 210, 220, and 230 for example in a coordinate system of one of the apparatus 210, 220, and 230, based on a geometric relationship among the apparatus 210, 220, and 230, and may determine the structure of the positioning network or system 200.

Similarly, the apparatus 220 may receive the information from the apparatus 210 in the step 140, and may obtain information on the distance between the apparatuses 210 and 220 measured by the apparatus 210 and the distance between the apparatuses 210 and 230 measured by the apparatus 210. Then, the apparatus 220 may also determine the coordinates of the apparatus 210, 220, and 230 in a coordinate system of one of the apparatus 210, 220, and 230 based on geometric relationship among the apparatus 210, 220, and 230, and then may determine the structure of the positioning network or system 200.

In another embodiment, the apparatus 210 may also determine AoA of another sensed apparatus. For example, as shown in FIG. 2, the apparatus 210 may determine that the apparatus 220 is in a direction with an AoA α₁ from the x axis in the coordinate system of the apparatus 210, and that the apparatus 230 is in a direction with an AoA α₂ from the x axis in the coordinate system of the apparatus 210. Then, the apparatus 210 may determine that the positions of the apparatuses 210, 220, and 230 relative to the apparatus 210 as (0, 0), (cos(α₁)*d₁ sin(α₁)*d₁), and (cos(α₂)*d₂, sin(α₂)*d₂). Further, the apparatus 210 may transmit, in the step 130, at least the positions of the apparatuses 220 and 230 relative to the apparatus 210, (cos(α₁)*d₁, sin(α₁)*d₁) and (cos(α₂)*d₂, sin(α₂)*d₂), to at least one of the apparatuses 220 and 230.

Similarly, the apparatus 220 may also determine that the apparatus 210 is in a direction with an AoA α₃ from the x axis in the coordinate system of the apparatus 220, and that the apparatus 230 is in a direction with an AoA α₄ from the x axis in the coordinate system of the apparatus 220. Thus, the apparatus 220 may determine that the positions of the apparatuses 210, 220, and 230 relative to the apparatus 220. Further, the apparatus 210 may transmit, in the step 130, at least the positions of the apparatuses 210 and 230 relative to the apparatus 220 to at least one of the apparatuses 210 and 230.

In an example, the apparatus 230 may perform actions similar to the above apparatuses 210 and 220. For example, the apparatus 230 may also determine the information on the positions of the apparatuses 210 and 220 relative to the apparatus 230 by sensing AoA and/or ToA of the apparatuses 210 and 220 relative to the apparatus 230, and then transmit the determined information to at least one of the apparatuses 210 and 220.

In another example, in the step 120 of the apparatus 230, the apparatus 230 may determine the information on the positions of the apparatuses 210 and 220 relative to the apparatus 230 based on information received from the apparatuses 210 and 220, for example in a case of lacking a function of measuring positions of other apparatuses. Then, the apparatus 230 may transmit the information to one or more of its sensed apparatuses such as 210 and 220 in the step 130, and may receive another information including positions of the apparatus 230 relative to one or more of its sensed apparatuses (which may be updated position information) from one or more of its sensed apparatuses in the step 140.

In an embodiment, one or more of the apparatuses 210, 220, and 230 may sense the space 240 and/or perform the example method 100 periodically (for example in a controlled/predetermined frequency), and/or in response to some event, for example, when receiving a signal from an apparatus or lacking a response from an apparatus.

Thus, for example as shown in FIG. 3, when the coordinate system of the apparatus 210 changes (for example, the orientation of the apparatus 210 is changed) and the positions of the apparatuses 220 and 230 are exchanged, the apparatuses 210, 220, and 230 may perform the example method 100 to determine the structure of the updated positioning network or system 300.

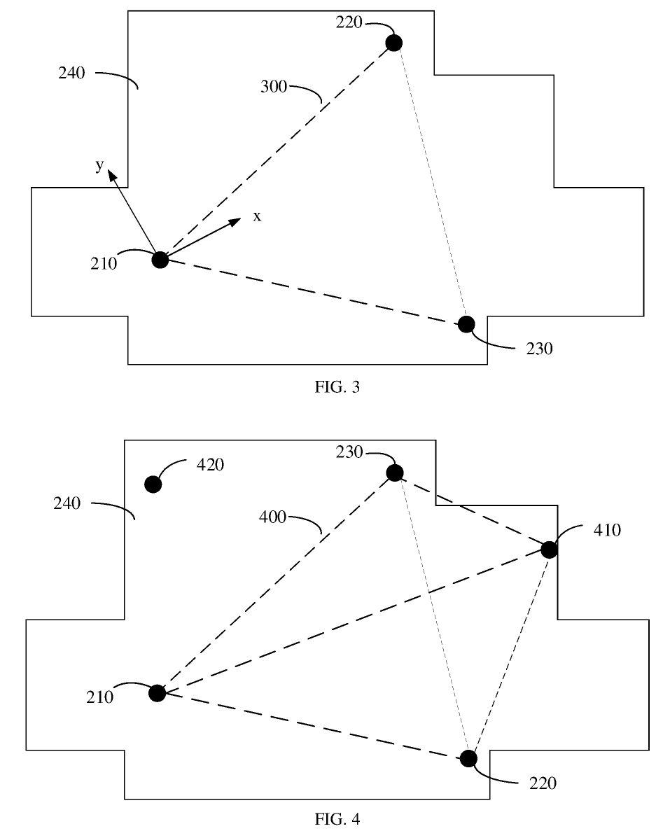

Further, for example as show in FIG. 4, when a new apparatus 410 supporting the example method 100 is configured or installed in the space 240, the apparatuses 210, 220, 230, and 410 may perform the example method 100 to determine the structure of the updated positioning network or system 400. Similar to the apparatuses 210, 220, and 230, the apparatus 410 may be, but is not limited to, a wireless apparatus which may be installed randomly (for example, without predetermined anchors or not at predetermined installation positions) and/or movable, such as a Wi-Fi device installed randomly in a room, a movable base station (e.g. a movable base station vehicle), or the like

In some embodiments, when a new apparatus is detected in the space 240, an authorization between the newly detected apparatus and one or more of the apparatuses in the positioning network or system may be performed before adding this newly detected apparatus into the positioning network or system. For example, for the newly detected apparatus 420 in FIG. 4, one or more of the apparatuses 210, 220, 230, and 410 may initiate an authorization procedure with the apparatus 420. Then, for example, in a case of lacking a valid response from the apparatus 420 or in a case of an authorization failure, the apparatus 420 may be refused to join the positioning network or system 400 by one or more of the apparatuses 210, 220, 230, and 410.

In various embodiments, in the example method 100, the information communication in the step 130 and/or the step 140 may be either direct or indirect, and the position of an apparatus relative to another apparatus in the system may be determined either by means of the sensing function of the apparatuses or based on information received from one or more apparatuses in the system.

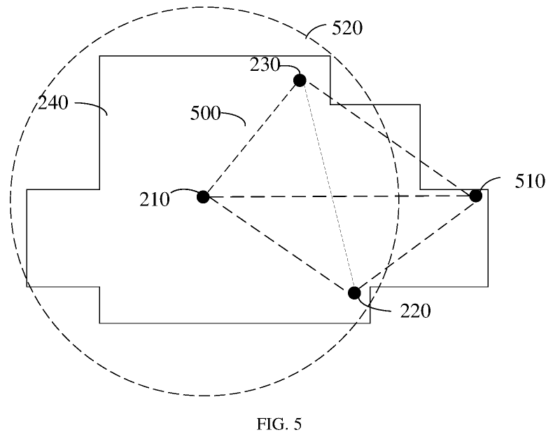

For example, as shown FIG. 5, in a case where the newly installed apparatus 510 falls outside of a scope 510 where the apparatus 210 transmitting information, the apparatus 220 and/or the apparatus 230 may sense or measure the positions of the apparatus 510 relative to the apparatus 220 and/or the apparatus 230, and then may transmit to the apparatus 210 the information including the measured positions of the apparatus 510 relative to the apparatus 220 and/or the apparatus 230. Then, the apparatus 210 may determine a position of the apparatus 510 relative to the apparatus 210 based on the information received from the apparatus 220 and/or the apparatus 230, so as to determine or establish the positioning network or system 500. The apparatus 510 may obtain information on the apparatus 210 in a similar way.

In another embodiment, for example, in the example of FIG. 5, the positioning network or system 500 may also include a part including the apparatuses 210, 220, and 230, and a part including the apparatuses 220, 230, and 510. In various embodiments, such one or more parts of the system may perform positioning for one or more UEs in the space 240 separately or collaboratively.

It is appreciated that the procedures of establishing or updating a positioning network or system are not limited to the above examples. For example, the apparatuses may perform the example method 100 to establish or scale or update a self-organized and scalable positioning network or system automatically, for example without predetermined anchors.

After the positioning network or system is established, one or more apparatuses in the system may sense one or more UEs in the space 240 and may track the one or more UEs in the space 240.

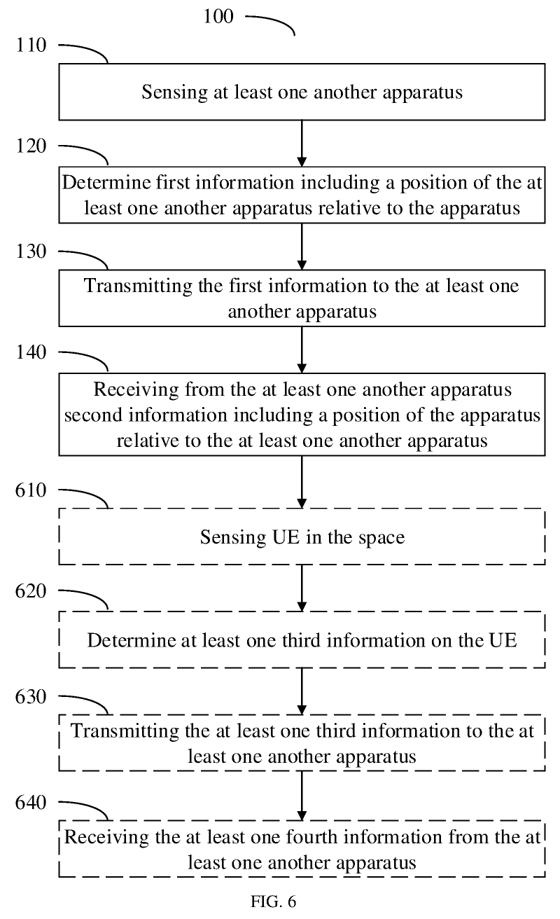

As shown in FIG. 6, the example method 100 may further include steps 610, 620, and 630. In the step 610, the apparatus may sense a UE in the space. In the step 620, the apparatus may determine at least one third information including one or more of an identity of the apparatus, an identity of the UE, at least one position of the UE relative to the apparatus, and at least one detection time of the position of the UE relative to the apparatus. In the step 630, the apparatus may transmit the at least one third information to the at least one another apparatus.

In some embodiments, as shown in FIG. 6, the example method 100 may further include a step 640. In the step 640, the apparatus may receive at least one fourth information from the one or more sensed apparatuses wherein the at least one fourth information may include one or more of the identity of the one or more sensed apparatuses, the identity of the UE, at least one position of the UE relative to the one or more sensed apparatuses, and at least one detection time of the position of the UE relative to the one or more sensed apparatuses.

In various embodiments, examples of the UE may include, but are not limited to, a mobile phone, smart home equipment, a vehicle, and the like.

In various embodiments, similar to the sensing among the apparatuses in the positioning network or system, the apparatus in the positioning network or system may sense the UE in the space in any suitable manners.

In various embodiments, similar to the determination of relative positions among the apparatuses in the positioning network or system, the apparatus in the positioning network or system may determine a position of the UE relative to the apparatus in any suitable manners, for example based on an AoA and/or a ToA of the UE relative to the UE, or based on information on one or more positions of the UE relative to one or more another sensed apparatuses which is received directly or indirectly from one or more another sensed apparatuses.

In various embodiments, similar to the information communications among the apparatuses in the positioning network or system, the information communication between the UE and the apparatuses in the positioning network or system may also be performed based on any suitable communication protocols such as TCP/IP and UDP. For example, the above at least one third information may be transmitted via broadcast. For example, the above at least one fourth information may be received via broadcast.

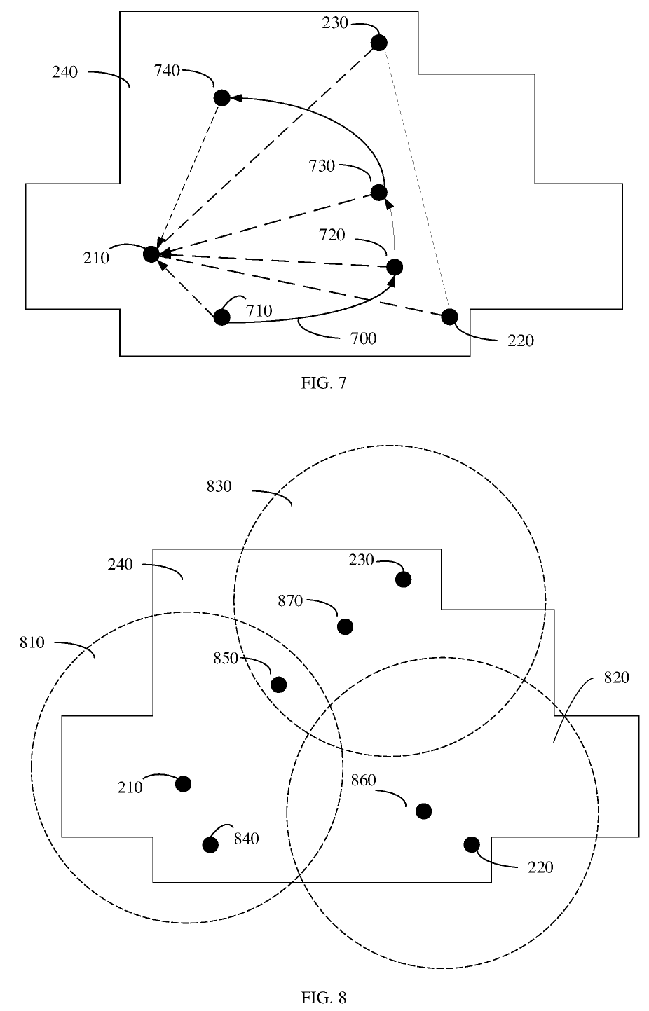

For example, as shown in FIG. 7, when a UE moves in the space 240, the apparatus 210 in the established positioning network or system including the apparatuses 210, 220, and 230 may sense the UE in the space 240 in the step 610. Then, for example, in the step 620, the apparatus 210 may determine a position 710 of the UE relative to the apparatus 210 at a time t₁, a position 720 of the UE relative to the apparatus 210 at a time t₂ after t₁, a position 730 of the UE relative to the apparatus 210 at a time t₃ after t₂, and a position 740 of the UE relative to the apparatus 210 at a time t₄ after t₃.

Then, in the step 630, the apparatus 210 may transmit information on one or more of the position 710 at the time t₁, the position 720 at the time t₂, the position 730 at the time t₃, the position 740 at the time t₄, and a trajectory 700 connecting the positions 710, 720, 730, and 740 in an order of time, to at least one of the apparatuses 220 and 230 in the system. For example, the apparatus 210 may broadcast such information. For example, the apparatus 210 may transmit such information to the apparatuses 220 and 230 separately. For example, the apparatus 210 may transmit a piece of information including the determined information on one or more of the position 710 at the time t₁, the position 720 at the time t₂, the position 730 at the time t₃, the position 740 at the time t₄, and a trajectory 700 to at least one of the apparatuses 220 and 230. For example, the apparatus 210 may transmit a piece of information including the position 710 at the time t₁ to at least one of the apparatuses 220 and 230, then transmit another piece of information including the position 720 at the time t₂ to at least one of the apparatuses 220 and 230, and so on. For example, the apparatus 210 may transmit such information to the apparatuses 220 and 230 together with information including a position of the apparatus 210 relative to at least one of the apparatuses 220 and 230.

In an embodiment, the apparatus 220 may also be able to sense the UE, may also determine one or more positions of the UE relative to the apparatus 220, and may also transmit the information including one or more positions of the UE relative to the apparatus 220 to at least one of the apparatuses 210 and 230. Similarly, the apparatus 230 may also be able to sense the UE, may also determine one or more positions of the UE relative to the apparatus 230, and may also transmit the information including one or more positions of the UE relative to the apparatus 230 to at least one of the apparatuses 210 and 220.

Then, the apparatus 210 may receive information including one or positions of the UE relative to the apparatus 220 and/or the apparatus 230 in the step 640. Similar to the transmission in the step 630, the information reception may be performed in any suitable manners. For example, the information including one or positions of the UE relative to the apparatus 220 and/or the apparatus 230 may be received together with the information including one or positions of the apparatus 210 relative to the apparatus 220 and/or the apparatus 230.

In an embodiment, as shown in FIG. 8, the apparatus 210 may sense and track the positions 840 and 850 in a sensing scope 810 of the apparatus 210, the apparatus 220 may sense and track the position 860 in a sensing scope 820 of the apparatus 220, and the apparatus 230 may sense and track the positions 870 and 850 in a sensing scope 830 of the apparatus 230. Then, the apparatuses 210, 220, and 230 may communicate or interchange (e.g. via broadcast) their determined information. For example, if the apparatus 210 is configure as the apparatus for later tasks such as positioning and prediction, the apparatus 220 may transmit the information including the position 860 of the UE relative to the apparatus 220 and the detection time to at least the apparatus 210. For example, if both apparatuses 210 and 230 are configure to cooperate for later tasks such as positioning and prediction, the apparatus 220 may transmit the information including the position 860 of the UE relative to the apparatus 220 and the detection time to at both apparatuses.

After determining and/or obtaining information including relative positions among apparatuses, in an embodiment, as shown in FIG. 9, the example method 100 may also include a step 910 of determining at least one location of the UE in the space.

For example, if the apparatus 210 is configure as the apparatus for later tasks such as positioning and prediction, the apparatus 210 may determine at least one location of the UE in the space 240 in the step 910 based on one or more of (1) at least one piece of first information including for example one or more of the identity of the apparatus 210, a position of the apparatuses 220 relative to the apparatus 210, a position of the apparatuses 230 relative to the apparatus 210, and so on, (2) at least one piece of second information including for example one or more of the identity of the apparatus 220, a position of the apparatus 210 relative to the apparatus 220, the identity of the apparatus 230, a position of the apparatus 210 relative to the apparatus 230, and so on, (3) at least one piece of third information including for example one or more of the identity of the apparatus 210, the identity of the UE, at least one position of the UE relative to the apparatus 210, and at least one detection time of the position of the UE relative to the apparatus 210, and so on, and (4) at least one piece of fourth information including for example one or more of , the identity of the UE, the identity of the apparatus 220, at least one position of the UE relative to the apparatus 220, at least one detection time of the position of the UE relative to the apparatus 220, the identity of the apparatus 230, at least one position of the UE relative to the apparatus 230, at least one detection time of the position of the UE relative to the apparatus 230, and so on.

For example, the apparatus 210 may determine the structure of the positioning network or system, a coordinate system based on one of the apparatuses 210, 220, and 230, and at least one location of the UE in the coordinate system, or the like, based on the received information and/or local information.

For example, the apparatus 210 may cooperate with the apparatus 220 and/or the apparatus 230 (e.g. as a distributed computing system) to determine the structure of the positioning network or system, a coordinate system based on one of the apparatuses 210, 220, and 230, at least one location of the UE in the coordinate system, or the like, based on their received information and/or their local information.

For example, as shown in FIG. 8, the apparatus 210 may determine the positions 840 and 850 of the UE in the coordinate system of the apparatus 210, and may transmit to the information including the positions 840 and 850 of the UE in the coordinate system of the apparatus 210 to the apparatus 220. Then, the apparatus 220 may transform the positions 840 and 850 of the UE in the coordinate system of the apparatus 210 to the positions in the coordinate system of the apparatus 220 so as to determine at least one location of the UE in the coordinate system of the apparatus 220.

For example, as shown in FIG. 8, the apparatus 210 may determine the position 850 of the UE in the coordinate system of the apparatus 210, and may receive information including the position 850 of the UE in the coordinate system of the apparatus 230. Then, one or both of the apparatuses 210 and 230 may determine a final position 850 of the UE in the coordinate system of the apparatus 210 or 220, and then transmit information including the final position 850 of the UE in the coordinate system of the apparatus 210 or 220 to one or more of the apparatuses 210, 220, and 230, so as to determine at least one location of the UE in the coordinate system of one of the apparatuses 210, 220, and 230.

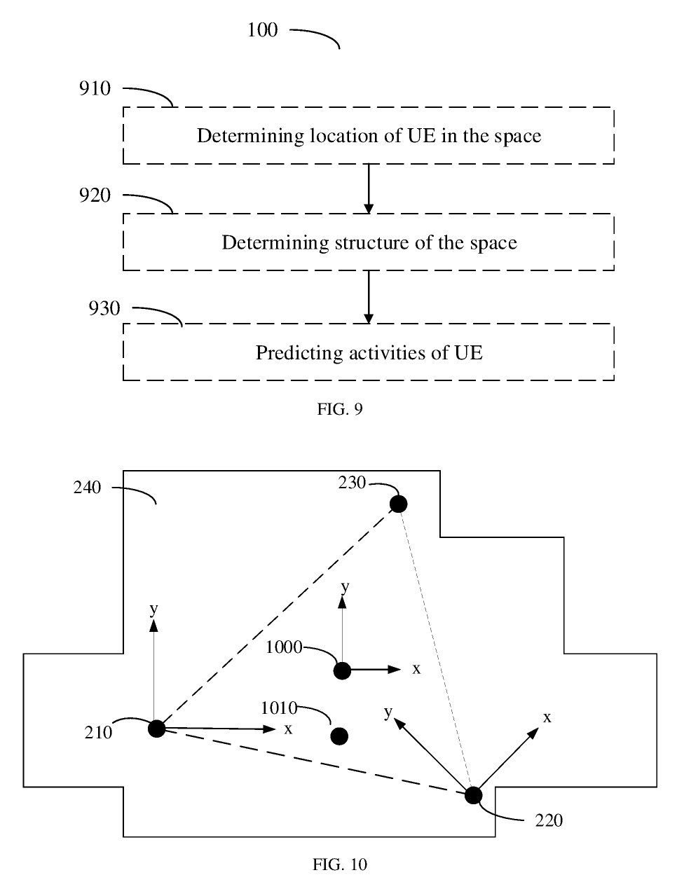

For example, one or more of the apparatuses 210, 220, and 230 may adjust their coordinate own system or negotiate a global coordinate system based on the exchanged or communicated information among the apparatuses in the positioning network or system. For example, as shown in FIG. 10, the apparatuses 210, 220, and 230 may cooperate to negotiate a global coordinate system in the space 240 with a global origin 1000 in the space 240 based on the relative positions among the apparatuses 210, 220, and 230. Then, for example, the apparatus 210 may determine a position 1010 of the UE relative to the apparatus 210 in the coordinate system of the apparatus 210, and then may transform the coordinate of the position 1010 in the global coordinate system, so as to determine a location of the UE in the space 240. Further, the apparatus 220 may determine a position 1010 of the UE relative to the apparatus 220 in the coordinate system of the apparatus 220, and then may transform the coordinate of the position 1010 in the global coordinate system, so as to determine a location of the UE in the space 240. For example, if the locations determined by the apparatuses 210 and 220 are different, any suitable manners may be adopted to solve the conflict, for example by selecting one or by computing a calibrated location of the UE in the space 240 based on the two locations determined by the apparatuses 210 and 220.

It is appreciated that one or more of the apparatuses in the system may adopt any suitable manners to determine at least one location of the UE in the space based on one or more pieces of information including at least one determined position of the UE relative to the one or more apparatuses in the respective coordinate systems of the one or more apparatuses, which are not limited to the above examples.

Further, as show in FIG. 9, the example method 100 may further include a step 920 for determining a structure of the space based on the at least one location of the UE in the space.

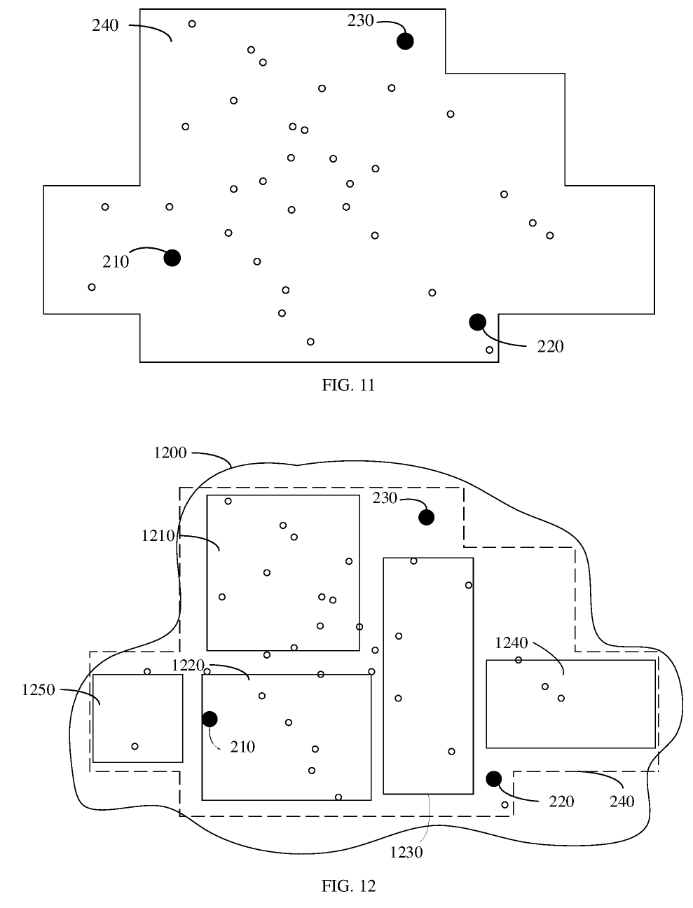

For example, as shown in FIG. 11, when the UE moves around in the space 240, one or more of the apparatus 210, 220, and 230 may determine at least one locations of the UE in the space 240, which is represented as small hollow circles in FIG. 11. Then, one or more of the apparatus 210, 220, and 230 may determine, for example, one or more of at least one outlier of the at least one location of the UE in the space 240, at least one cluster of the at least one location of the UE in the space 240, at least one trajectory of the at least one location of the UE in the space 240, and a relationship between the at least one location of the UE in the space and at least one detection time.

Then, for example as shown in FIG. 12, one or more of the apparatus 210, 220, and 230 may determine or infer an outline 1200 of the space 240 for example based on the outliers of the determined locations of the UE in the space 240, and may determine or infer a layout of the space 240 including e.g. the subspaces 1210, 1220, 1230, 1240, and 1250, for example based on clusters of the determined locations of the UE in the space 240.

Further, one or more of the apparatus 210, 220, and 230 may determine a structure of the space, for example based on at least one of at least one location of the UE, at least one detection time of the at least one location of the UE, at least one duration of the at least one location of the UE, one or more locations where the UE appears and/or disappears, and so on. For example, one or more of the apparatus 210, 220, and 230 may determine or infer functions of the subspaces 1210, 1220, 1230, 1240, and 1250, based on at least one of at least one location of the UE, at least one time of the at least one location of the UE, at least one duration of the at least one location of the UE, one or more locations where the UE appears and/or disappears, and so on. For example, in a case where the space 240 is a family house, if a certain number of locations of the UE corresponding to the subspace 1250 are measured or sensed at midnight, one or more of the apparatus 210, 220, and 230 may determine or infer that the subspace 1250 may be a bedroom. For example, in a case where the space 240 is a mall, if a certain number of locations of the UE corresponding to the subspace 1240 are measured or sensed at lunch time, one or more of the apparatus 210, 220, and 230 may determine or infer that the subspace 1240 may be a restaurant. For example, the locations where the UE disappears may be treated as entry doors.

In another embodiment, for example as shown in FIG. 9, the example method 100 may also include a step 930 for predicting an activity of the UE in the space based on the at least one location of the UE in the space.

For example, in FIG. 12, one or more of the apparatus 210, 220, and 230 may determine, for example, one or more of at least one outlier of the at least one location of the UE in the space 240, at least one cluster of the at least one location of the UE in the space 240, at least one trajectory of the at least one location of the UE in the space 240, and a relationship between the at least one location of the UE in the space and at least one detection time. Then, for example, in a case where the space 240 is a family house, if a certain number of locations of the UE corresponding to the subspace 1210 are measured or sensed after dinner and before midnight, one or more of the apparatus 210, 220, and 230 may predict that the living style of this family may include activities (e.g. watching TV) in the living room after dinner.

In various embodiments, one or more of the apparatus 210, 220, and 230 may implement the steps 910, 920, and 930 in any suitable manners, for example by utilizing technologies such as machine learning and artificial intelligence.

In another embodiments, the example method 100 may further include a step where the apparatus transmit one or more of the above sensed or inferred information to the UE or a server (e.g. a server on the side of the positioning based service provider), including, but not limited to, the information including the positions of the apparatus relative to the other sensed apparatuses, the information including the positions of the other sensed apparatuses relative to the apparatus, the information including the positions of the UE relative to the apparatus, the information including the positions of the UE relative to the other sensed apparatuses, the information including at least one determined locations of the UE in the space, the information including the inferred structure of the space, and so on.

In some embodiments, the tasks such as positioning of the UE, determination of the structure of the space, and prediction of the activity of the UE, may be invoked or triggered for example by the UE or positioning based service provider.

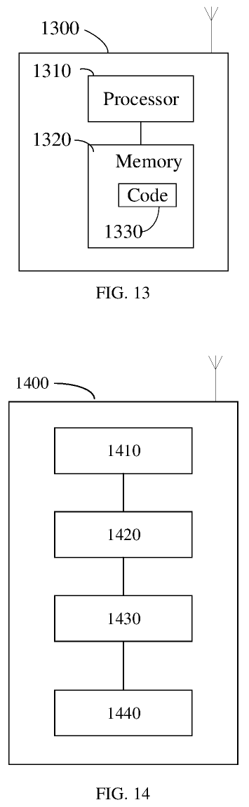

FIG. 13 illustrates an example apparatus 1300 for positioning in an embodiment, which may perform the example method 100 and may be used establish the above self-organized and scalable positioning network or system, including the above apparatus 210, 220, or 230.

As shown in FIG. 13, the example apparatus 1300 may include at least one processor 1310 and at least one memory 1320 that may include computer program code 1330. The at least one memory 1320 and the computer program code 1330 may be configured to, with the at least one processor 1310, cause the apparatus 1300 to perform at least the example method 100 described above. For example, the at least one memory 1320 and the computer program code 1330 may be configured to, with the at least one processor 1310, cause the apparatus 1300 to perform at least sensing at least one another apparatus in a space including the apparatus, determining first information including a position of the at least one another apparatus relative to the apparatus, transmitting the first information to the at least one another apparatus, and receiving from the at least one another apparatus second information including a position of the apparatus relative to the at least one another apparatus.

In various example embodiments, the at least one processor 1310 in the example apparatus 1300 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1310 may also include at least one other circuitry or element not shown in FIG. 13.

In various example embodiments, the at least one memory 1320 in the example apparatus 1300 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 1320 may include, but are not limited to, an electric, a magnetic, an optical, an electromagnetic, an infrared, or a semiconductor system, apparatus, or device or any combination of the above.

Further, in various example embodiments, the example apparatus 1300 may also include at least one other circuitry, element, and interface, for example at least one I/O interface, at least one antenna element, and the like.

In various example embodiments, the circuitries, parts, elements, and interfaces in the example apparatus 1300, including the at least one processor 1310 and the at least one memory 1320, may be coupled together via any suitable connections including, but not limited to, buses, crossbars, wiring and/or wireless lines, in any suitable ways, for example electrically, magnetically, optically, electromagnetically, and the like.

In various example embodiments, the example apparatus 1300 may be, but is not limited to, a wireless apparatus which is installed randomly (for example, without predetermined anchors or not at predetermined installation positions) and/or movable, such as a Wi-Fi device installed randomly in a room (e.g. including multiple Wi-Fi devices from Mesh Wi-Fi), a movable base station (e.g. a movable base station vehicle), or the like.

It is appreciated that the structure of the apparatus, which may perform the example method 100 and may be used establish the above self-organized and scalable positioning network or system, is not limited to the above example apparatus 1300.

FIG. 14 illustrates another example apparatus 1400 which may perform the example method 100 and may be used establish the above self-organized and scalable positioning network or system.

As shown in FIG. 10, the example apparatus 1400 may include means 1410 for performing the step 110 of the example method 100, means 1420 for performing the step 120 of the example method 100, means 1430 for performing the step 130 of the example method 100, and means 1440 for performing the step 140 of the example method 100. In one or more another example embodiments, at least one I/O interface, at least one antenna element, and the like may also be included in the example apparatus 1400.

In some example embodiments, examples of means 1410, 1420, 1430, and 1440 may include circuitries. For example, an example of means 1410 may include a circuitry configured to perform the step 110 of the example method 100, an example of means 1420 may include a circuitry configured to perform the step 120 of the example method 100, an example of means 1430 may include a circuitry configured to perform the step 130 of the example method 100, and an example of means 1440 may include a circuitry configured to perform the step 140 of the example method 100. In some example embodiments, examples of means may also include software modules and any other suitable function entities.

In some embodiments, the example apparatus 1400 may further include one or more additional means for performing one or more of the steps 610, 620, 630, 640, 910, 920, and 930.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Further, as described above, another example embodiment may relate to a positioning network or system including at least one first apparatus and at least one second apparatus. The at least one first apparatus may be configured to sense the at least one second apparatus, to determine first information including a position of the at least one second apparatus relative to the at least one first apparatus, to transmit the first information, and to receive second information including a position of the at least one first apparatus relative to the at least one second apparatus, and the at least one second apparatus may be configured to sense the at least one first apparatus, to determine the second information, to transmit the second information, and to receive the first information. Examples of the at least one first apparatus and the at least one second apparatus may include the above apparatus 210, 220, and 230, and may include, but are not limited to, the structures of the above example apparatus 1300 and/or the above example apparatus 1400.

In the above examples, tasks such as UE positioning, determination of the structure of the space, and the prediction of the activities of the UE are performed by one or more apparatuses in the positioning network or system, for example one or more of the apparatuses 210, 220, and 230 in the above examples.

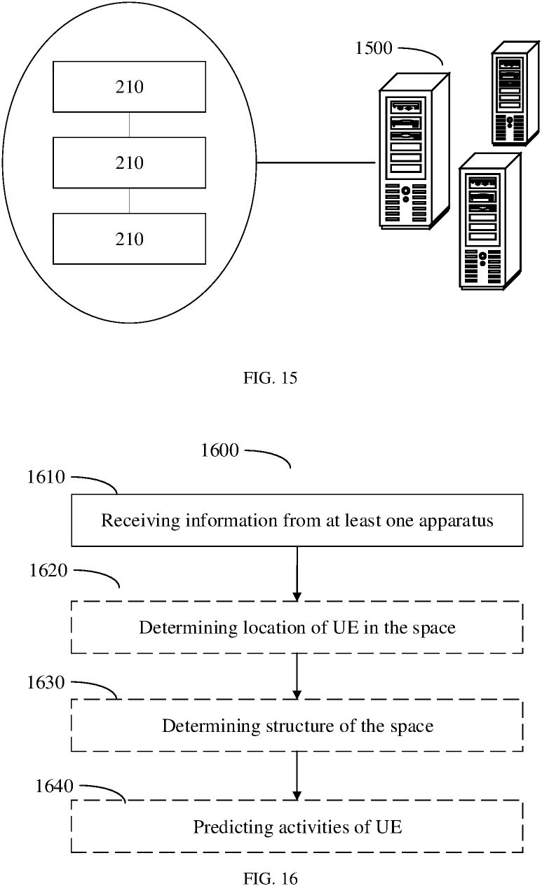

In another embodiment, the tasks such as UE positioning, determination of the structure of the space, and the prediction of the activities of the UE may be performed by one or more servers. For example, as shown in FIG. 15, one or more of the apparatuses 210, 220, and 230 in the positioning network or system in various embodiments may transmit one or more of the above sensed or inferred information to the server 1500 (e.g. a server on the side of the positioning based service provider), which information may include, but not limited to, the information including the positions of the apparatus relative to the other sensed apparatuses, the information including the positions of the other sensed apparatuses relative to the apparatus, the information including the positions of the UE relative to the apparatus, the information including the positions of the UE relative to the other sensed apparatuses, the information including at least one determined locations of the UE in the space, the information including the inferred structure of the space, and so on.

Then, the server may perform the tasks such as UE positioning, determination of the structure of the space, and the prediction of the activities of the UE. That is, for example, the above steps 910, 920, 930 in the example method 100 may be performed by the server 1500.

In another embodiments, the server 1500 may cooperate with one or more of the apparatuses in the positioning system, for example, one or more of the apparatuses 210, 220, and 230, to perform the tasks such as UE positioning, determination of the structure of the space, and the prediction of the activities of the UE, so as to form a distributed computing system.

FIG. 16 illustrates an example method 1600 which may be performed by the server 1500.

As shown in FIG. 16, the example method 1600 may include a step of receiving information from at least one apparatus (e.g. one or more of the above apparatuses 210, 220, and 230 in the space 240), wherein the information may include, but is not limited to, one or more of (1) the identity of the at least one apparatus, a position relationship among the at least apparatus, the structure and/or configuration of the positioning network including the at least one apparatus, at least one position of the UE in the space relative to the at least one apparatus, the identity of the UE, at least one detection time of the at least one position of the UE in the space relative to the at least one apparatus, at least one location of the UE in the space, a structure of the space, and so on.

In various embodiments, the information may be received based on any suitable communication protocols such as TCP/IP. For example, the information may be received via a broadcast channel. Further, the information may be received via wire or wireless manner.

As shown in FIG. 16, the example method 1600 may further include a step 1620 for determining the at least one location of the UE in the space based on the information, which is similar to the step 910 in the example method 100.

Further, as shown in FIG. 16, the example method 1600 may further include a step 1630 for determining a structure of the space based on the at least one location of the user equipment in the space, which is similar to the step 920 in the example method 100.

Further, as shown in FIG. 16, the example method 1600 may further include a step 1640 for predicting an activity of the UE in the space based on the at least one location of the UE in the space, which is similar to the step 930 in the example method 100.

For example, the structure of the space and/or the activity of the UE may be determined or predicted based on one or more of at least one outlier of the at least one location of the UE in the space, at least one cluster of the at least one location of the UE in the space, at least one trajectory of the at least one location of the UE in the space, and a relationship between the at least one location of the UE in the space and at least one detection time in the information.

In another embodiment, the example method 1600 may be performed by the UE, so that the tasks such as UE positioning, determination of the structure of the space, and the prediction of the activities of the UE may be processed by the UE itself.

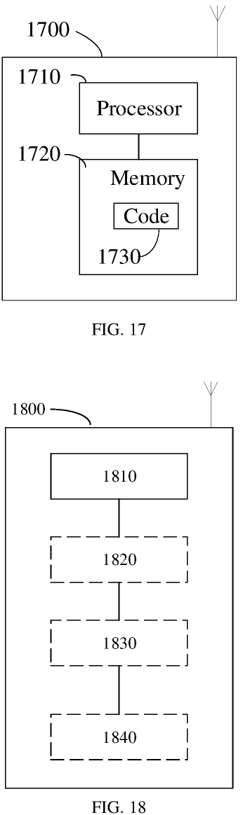

FIG. 17 illustrates an example apparatus 1700 which may be at least a part of the UE supporting the example method 1600.

As shown in FIG. 17, the example apparatus 1700 may include at least one processor 1710 and at least one memory 1720 that may include computer program code 1730. The at least one memory 1720 and the computer program code 1730 may be configured to, with the at least one processor 1710, cause the apparatus 1700 at least to perform at least the example method 1600 described above.

In various example embodiments, the at least one processor 1710 in the example apparatus 1700 may include, but not limited to, at least one hardware processor, including at least one microprocessor such as a CPU, a portion of at least one hardware processor, and any other suitable dedicated processor such as those developed based on for example FPGA and ASIC. Further, the at least one processor 1710 may also include at least one other circuitry or element not shown in FIG. 17.

In various example embodiments, the at least one memory 1720 in the example apparatus 1700 may include at least one storage medium in various forms, such as a volatile memory and/or a non-volatile memory. The volatile memory may include, but not limited to, for example, a RAM, a cache, and so on. The non-volatile memory may include, but not limited to, for example, a ROM, a hard disk, a flash memory, and so on. Further, the at least memory 1720 may include, but are not limited to, an electric, a magnetic, an optical, an electromagnetic, an infrared, or a semiconductor system, apparatus, or device or any combination of the above.

Further, in various example embodiments, the example apparatus 1700 may also include at least one other circuitry, element, and interface, for example at least one I/O interface, at least one antenna element, and the like.

In various example embodiments, the circuitries, parts, elements, and interfaces in the example apparatus 1700, including the at least one processor 1710 and the at least one memory 1720, may be coupled together via any suitable connections including, but not limited to, buses, crossbars, wiring and/or wireless lines, in any suitable ways, for example electrically, magnetically, optically, electromagnetically, and the like.

FIG. 18 illustrates another example apparatus 1800 which may be at least a part of the UE supporting the example method 1600.

As shown in FIG. 18, the example apparatus 1800 may include means 1810 for performing the step 1610 of the example method 1600. In one or more another example embodiments, the example apparatus 1800 may further include at least one I/O interface, at least one antenna element, and the like. As shown in FIG. 18, the example method 1800 may further include means 1820 for performing the step 1620 of the example method 1600, means 1830 for performing the step 1630 of the example method 1600, and means 1840 for performing the step 1640 of the example method 1600.

In various example embodiments, examples of means 1810 may include circuitries. For example, an example of means 1810 may include a circuitry configured to perform the step 1610 of the example method 1600, an example of means 1820 may include a circuitry configured to perform the step 1620 of the example method 1600, an example of means 1830 may include a circuitry configured to perform the step 1630 of the example method 1600, and an example of means 1840 may include a circuitry configured to perform the step 1640 of the example method 1600. In some example embodiments, examples of means may also include software modules and any other suitable function entities.

Another example embodiment may relate to computer program codes or instructions which may cause an apparatus to perform at least respective methods described above, such as computer program codes or instructions causing an apparatus to perform at least the above example method 100, and computer program codes or instructions causing a server or a UE to perform at least the above example method 1600.

Another example embodiment may be related to a computer readable medium having such computer program codes or instructions stored thereon. In various example embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While some example embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the various embodiments described above can be combined to provide further embodiments. The accompanying claims and their equivalents are intended to cover such forms or modifications as would fall within the scope and spirit of the disclosure.

1-44. (canceled)

45. An apparatus comprising:
at least one processor; and
at least one memory including computer program code, the at least one memory and the computer program code being configured to, with the at least one processor, cause the apparatus to perform at least sensing at least one another apparatus in a space including the apparatus, determining first information including a position of the at least one another apparatus relative to the apparatus, transmitting the first information to the at least one another apparatus, and receiving from the at least one another apparatus second information including a position of the apparatus relative to the at least one another apparatus.

46. The apparatus of claim 45, wherein the first information is transmitted via at least one of broadcast, Transmission Control Protocol/Internet Protocol (TCP/IP), and User Datagram Protocol (UDP), and/or the second information is received via at least one of broadcast, TCP/IP, and UDP.

47. The apparatus of claim 45, wherein the at least one memory and the computer program code is further configured to, with the at least one processor, cause the apparatus to perform sensing a user equipment in the space, determining at least one third information including one or more of an identity of the apparatus, an identity of the user equipment, at least one position of the user equipment relative to the apparatus, and at least one detection time of the position of the user equipment relative to the apparatus, and transmitting the at least one third information to the at least one another apparatus.

48. The apparatus of claim 47, wherein the at least one third information is transmitted via at least one of broadcast, TCP/IP, and UDP.

49. The apparatus of claim 47, wherein the at least one memory and the computer program code is further configured to, with the at least one processor, cause the apparatus to perform determining at least one location of the user equipment in the space based on at least one of the first information, the second information, the at least one third information, and at least one fourth information from the at least one another apparatus, the at least one fourth information including one or more of an identity of the at least one another apparatus, the identity of the user equipment, at least one position of the user equipment relative to the at least one another apparatus, and at least one detection time of the position of the user equipment relative to the at least one another apparatus.

50. The apparatus of claim 49, wherein the at least one memory and the computer program code is further configured to, with the at least one processor, cause the apparatus to perform determining a structure of the space based on the at least one location of the user equipment in the space.

51. The apparatus of claim 49, wherein the at least one memory and the computer program code is further configured to, with the at least one processor, cause the apparatus to perform predicting an activity of the user equipment in the space based on the at least one location of the user equipment in the space.

52. The apparatus of claim 50, wherein the at least one memory and the computer program code is further configured to, with the at least one processor, cause the apparatus to perform determining one or more of at least one outlier of the at least one location of the user equipment in the space, at least one cluster of the at least one location of the user equipment in the space, at least one trajectory of the at least one location of the user equipment in the space, and a relationship between the at least one location of the user equipment in the space and at least one detection time in the at least one information in the at least one third information and/or the at least one fourth information.

53. The apparatus of claim 45, wherein the at least one memory and the computer program code is further configured to, with the at least one processor, cause the apparatus to perform transmitting at least one of the first information, the second information, at least one location of a user equipment in the space, and information on a structure of the space to the user equipment.

54. An apparatus comprising:
at least one processor; and
at least one memory including computer program code, the at least one memory and the computer program code being configured to, with the at least one processor, cause the apparatus to perform receiving information from at least one another apparatus in a space, the information including one or more of an identity of the at least one another apparatus, a position relationship among the at least one another apparatus, and at least one position of the apparatus in the space relative to the at least one another apparatus.

55. The apparatus of claim 54, wherein the information further includes at least one of an identity of the apparatus and at least one detection time of the at least one position of the apparatus in the space relative to the at least one another apparatus.

56. The apparatus of claim 54, wherein the at least one memory and the computer program code is further configured to, with the at least one processor, cause the apparatus to perform determining the at least one location of the apparatus in the space based on the information.

57. The apparatus of claim 56, wherein the at least one memory and the computer program code is further configured to, with the at least one processor, cause the apparatus to perform determining a structure of the space based on the at least one location of the apparatus in the space.

58. The apparatus of claim 56, wherein the at least one memory and the computer program code is further configured to, with the at least one processor, cause the apparatus to perform predicting an activity of the apparatus in the space based on the at least one location of the apparatus in the space.

59. The apparatus of claim 57, wherein the at least one memory and the computer program code is further configured to, with the at least one processor, cause the apparatus to perform determining one or more of at least one outlier of the at least one location of the apparatus in the space, at least one cluster of the at least one location of the apparatus in the space, at least one trajectory of the at least one location of the apparatus in the space, and a relationship between the at least one location of the apparatus in the space and at least one detection time in the information.

60. The apparatus of claim 54, wherein the apparatus is at least a part of a user equipment.

61. A method comprising:
sensing, at an apparatus in a space, at least one another apparatus in the space;
determining first information including a position of the at least one another apparatus relative to the apparatus;
transmitting the first information to the at least one another apparatus; and
receiving from the at least one another apparatus second information including a position of the apparatus relative to the at least one another apparatus.

62. The method of claim 61, further comprising:
determining the position of the at least one another apparatus relative to the apparatus based on at least one of an angle of arrival and a time of arrival of the at least one another apparatus relative to the apparatus.

63. The method of claim 61, further comprising:
sensing a user equipment in the space;
determining at least one third information including one or more of an identity of the apparatus, an identity of the user equipment, at least one position of the user equipment relative to the apparatus, and at least one detection time of the position of the user equipment relative to the apparatus; and
transmitting the at least one third information to the at least one another apparatus.

64. The method of claim 63, further comprising:
determining the at least one position of the user equipment relative to the apparatus based on one or both of at least one angle of arrival and at least one time of arrival of the user equipment relative to the apparatus.
